(19) United States
(12) Patent Application Publication
(10) Pub. No.: US 2007/0226325 A1
(43) Pub. Date: Sep. 27, 2007

(54) Virtual private network service status management

(75) Inventors: Satvinder Singh Bawa, Ottawa (CA); Hamdy Mahmoud Farid, Kanata (CA); Susan Patricia Callow, Kanata (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(73) Assignee: Alcatel

(21) Appl. No.: 11/388,083

(22) Filed: Mar. 23, 2006

(51) Int. Cl. G06F 15/173

(52) U.S. Cl. 709/223

(57) ABSTRACT

Virtual Private Network (VPN) service status management apparatus, methods, Graphical User Interfaces, and data structures are disclosed. A service-specific status of a service site in a communication system with respect to a VPN service is managed independently of a service-specific status of the service site with respect to a different VPN service with which the service site is associated. A service site may thus have a different service-specific status in different VPN services. Management of entire VPN services is also facilitated, in that changes in the overall status of a VPN service affects service sites only in respect of that VPN service. In one embodiment, status management is accomplished through automatic manipulation of Route Targets (RTs) in VPN Routing and Forwarding (VRF) tables.

### FIELD OF THE INVENTION

This invention relates generally to communications and, in particular, to managing Virtual Private Network (VPN) services.

### BACKGROUND

In a VPN service, such as a provisioned Layer 3 (L3) VPN service based on the methods defined in RFC-2547, there may be a need to disable the entire VPN service for a short, or extended, period of time. RFC-2547 refers to a Request for Comments document of The Internet Society, by E. Rosen et al., entitled “BGP/MPLS VPNs”, and published in March 1999. There may also be occasions on which the service flow to a single service site, illustratively customer premises, is to be disabled for some time.

Accomplishing such disruptions in a manner so as to contain a disruption to a single VPN service is a non-trivial exercise. A service site may be connected to more than one VPN service, for example, in which case it might not be desirable to completely disable information flow to and/or from a service site in order to disable its participation from a single VPN service.

One challenge in avoiding the interruption of service site communications in all VPN services is that routing information such as VPN Routing and Forwarding (VRF) tables of a service site must be reconfigured to re-regulate the flow of information to only the VPN services for which the service site is to continue to communicate. Performing such a re-configuration while taking into account the membership of the service site in other VPN services tends to be extremely error prone and tedious, especially when a communication system includes many service sites that are part of many VPN services.

U.S. patent application Ser. No. 10/845,517, published on Apr. 28, 2005 as Publication No. 2005/0091482, and entitled “SYSTEMS AND METHODS FOR INFERRING SERVICES ON A NETWORK”, discloses systems and methods for managing services on a network. Topologically relevant network information concerning nodes, interfaces, connections and/or protocols is received, conflicts in the received information are resolved, a network topology is determined from the received and resolved information and is stored, and one or more services are inferred based on the stored topology. In one embodiment, to infer the existence of a VPN, a Network Management System (NMS) may determine from stored network object information, such as VRF tables or portions of such tables exchanged between nodes as part of Border Gateway Protocol (BGP) update messages, whether VPN(s) exist on a network. For example, the NMS may determine from VRF information that there is a route target named “VPN A” which is exported by a node A. Similarly, a node C may also import a route target named “VPN A”. The NMS may then be able to infer based on the information it receives that nodes A and C have a VPN between them named “VPN A”.

The above-noted publication provides background information on managing VPN services, and describes how an NMS may infer the existence of such services by examining VRF information such as route targets (RTs) exchanged between routers in BGP update messages. However, it does not address the problems associated with disabling a service site in one VPN service without also disabling the service site for other VPN services.

Thus, there remains a need for improved VPN service management techniques.

### SUMMARY OF THE INVENTION

Embodiments of the present invention provide a mechanism for managing the VPN connectivity of service sites while maintaining the connectivity status of those sites with respect to other VPN services. The states of VPN service sites in a VPN service may be controlled, for example, by modifying the RT information in VRF tables of customer nodes that subscribe to the VPN service.

According to an aspect of the invention, an apparatus includes a configuration interface for exchanging VPN service configuration information with a communication system, and a status management module, operatively coupled to the configuration interface, for managing a service-specific status of a service site in the communication system with respect to a VPN service independently of a service-specific status of the service site with respect to a different VPN service with which the service site is associated.

The status management module may be configured to manage the service-specific status of the service site with respect to the VPN service by managing a communication traffic routing table associated with the VPN service.

In some embodiments, the service site includes Customer Edge (CE) communication equipment operatively coupled to Provide Edge (PE) communication equipment, and the status management module is configured to manage the service-specific status of the service site with respect to the VPN service by managing a Route Target (RT) configuration of the PE communication equipment.

The VPN service may include the service site and a further service site, in which case the status management module or the service site communicates a change in the service-specific status of the service site to the further service site.

If the VPN service comprises the service site and a further service site, and the further service site includes CE communication equipment operatively coupled to PE communication equipment, the status management module or the PE communication equipment at the service site may communicate a change in the service-specific status of the service site to the PE communication equipment at the further service site.

The apparatus may also include a user interface (UI), operatively coupled to the status management module, for allowing a user to select the VPN service, the service site, and a status management function. The status management module may perform the selected status management function for the service-specific status of the service site with respect to the VPN service responsive to a user selection of the VPN service, the service site, and the status management function.

In some embodiments, the UI provides a visual representation of the service site and the service-specific status of the service site with respect to the VPN service responsive to a user selection of the VPN service, and the status management module performs the selected status management function for the service-specific status of the service site with respect to the VPN service responsive to a user selection of the status management function.

The status management module may be further operable for managing a status of the VPN service. In this case, the status management module may manage the service-specific status of the service site with respect to the VPN service in accordance with a status of the VPN service.

The apparatus may be implemented, for example, in a network management system.

Another aspect of the invention provides a machine-implemented method of managing a status of a service site in a communication system, where the service site has been configured for participation in a plurality of different Virtual Private Network (VPN) services. The method includes determining a service-specific status management function to be performed for the service site with respect to a VPN service of the plurality of VPN services, and automatically performing the determined status management function for the service site with respect to the VPN service while maintaining a service-specific status for the service site with respect to a different VPN service of the plurality of VPN services.

The operation of performing may involve identifying an RT associated with the VPN service, and removing the identified RT from a VRF table of the service site in the communication system.

In some embodiments, the operation of determining involves determining a status management function to be performed for the VPN service, and determining the service-specific status management function to be performed for the service site based on the determined status management function to be performed for the VPN service.

A Graphical User Interface (GUI) is also provided, and includes a graphical element identifying a VPN service, which includes a service site, and a graphical element indicating a service-specific status of the service site with respect to the VPN service.

If the VPN service includes a plurality of service sites including the service site, the graphical element indicating a service-specific status includes a respective graphical element indicating a service-specific status of each service site of the plurality of service sites.

The GUI may also include a graphical element indicating a status of the VPN service.

In some embodiments, the graphical element indicating the service-specific status includes a functional graphical element. The functional graphical element provides access to a status management function for managing the service-specific status of the service site with respect to the VPN service. Where the service site is associated with a plurality of different VPN services including the VPN service, the status management function manages the service-specific status of the service site with respect only to the VPN service.

In accordance with a further aspect of the invention, a computer-readable medium stores a data structure that includes an identifier of a VPN service, the VPN service including a service site, and an indication of a service-specific status of the service site with respect to the VPN service.

If the service site is associated with a plurality of different VPN services including the VPN service, the data structure further includes an identifier of the service site, the identifier of a VPN service includes a respective identifier of each VPN service of the plurality of VPN services, and the indication includes a respective indication of a service-specific status of the service site with respect to each VPN service of the plurality of VPN services.

The VPN service may include a plurality of service sites including the service site, in which case the indication includes a respective indication of a service-specific status of each service site of the plurality of service sites.

In some embodiments, where the service site is associated with a plurality of different VPN services including the VPN service, the data structure includes a plurality of data structures, with each data structure of the plurality of data structures including an identifier of the service site, an identifier of a respective one of the plurality of VPN services, relationship information associated with the service site and the one of the plurality of VPN services, and an indication of a service-specific status of the service site with respect to the one of the plurality of VPN services.

If the VPN service include a plurality of service sites including the service site, the data structure may include a plurality of data structures, with each data structure of the plurality of data structures including an identifier of the VPN service, an identifier of a respective one of the plurality of service sites, relationship information associated with the VPN service and the one of the plurality of service sites, and an indication of a service-specific status of the one of the plurality of service sites with respect to the VPN service.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of a communication system.

FIG. 2 is a block diagram of a VPN service status management apparatus.

FIG. 3 is a block diagram of communication equipment.

FIG. 4 is a block diagram of a GUI.

FIG. 5 is a block diagram of a VPN service status management method.

FIG. 6 is a block diagram of a VPN service site data structure.

FIG. 7 is a block diagram of a VPN service data structure.

FIG. 8 is a block diagram of another VPN service site data structure.

FIG. 9 is a block diagram of another VPN service data structure.

FIG. 10 is a block diagram of a relationship data structure.

### DETAILED DESCRIPTION OF PREFERRED EMBODIMENTS

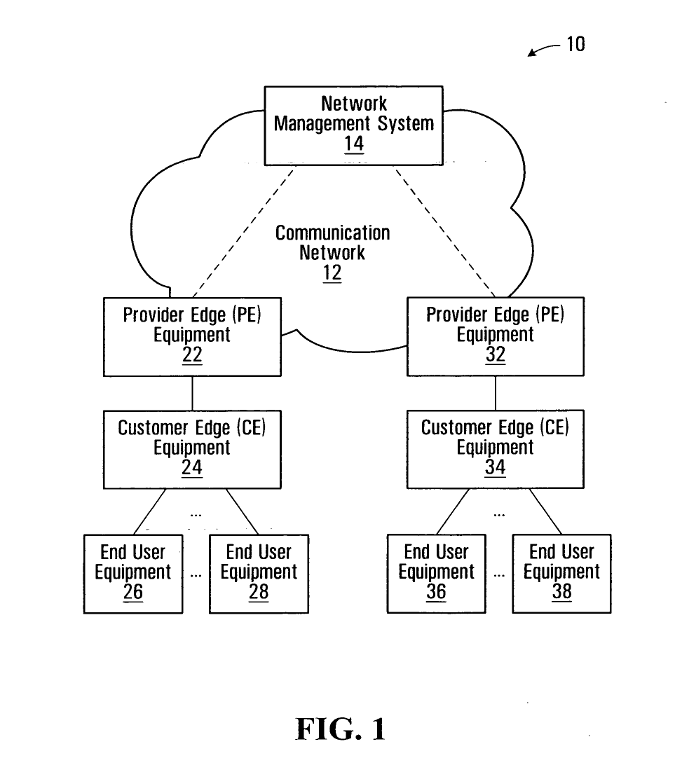

FIG. 1 is a block diagram of a communication system in which embodiments of the invention may be implemented. The communication system 10 includes a communication network 12 that is managed by an NMS 14. Service provider edge communication equipment associated with service providers, represented as Provider Edge (PE) equipment 22, 32 in the communication network 12, provides access to the communication network for customer edge (CE) equipment 24, 34, which is in turn connected to end user equipment 26, 28, 36, 38.

Although many installations of PE equipment, as well as other border or core equipment such as core routers and switches, may be connected to or within the communication network 12, only two installations of PE equipment 22, 32 have been shown in FIG. 1 in order to avoid overly complicating the drawing. The techniques described herein may be extended to communications between more than two installations of PE equipment, whether those communications are through direct or indirect communication paths.

More generally, embodiments of the invention may be implemented in communication systems having fewer, further, or different components with similar or different interconnections than shown in FIG. 1. Other PE/CE topologies are possible, for example. In addition, not all types of VPN services will employ the PE/CE architecture that has been defined for BGP/MPLS VPN services. Similarly, as noted above, communication traffic may be exchanged between edge communication equipment through intermediate network elements that have not been explicitly shown.

Many different equipment topologies, protocols, and transfer schemes within the communication network 12, between the communication network and other equipment such as the CE equipment 24, 34 and the end user equipment 26, 28, 36, 38 are also possible. The particular components shown in FIG. 1 are intended as illustrative examples of types of communication equipment in conjunction with which embodiments of the invention may be implemented. Although PE equipment and CE equipment, for instance, are often associated with specific protocols or transfer mechanisms, the invention is not limited thereto.

Accordingly, it should be appreciated that the system of FIG. 1, as well as the contents of the other drawings, are intended solely for illustrative purposes, and that the present invention is in no way limited to the particular example embodiments explicitly shown in the drawings and described herein.

Those skilled in the art will be familiar with various types of communication networks and equipment that may be implemented in the communication system of FIG. 1, and the normal operations associated with such a communication system. In general, end user equipment 26, 28 and 36, 38 is provided with access to the communication network 12 through the CE equipment 24, 34 and the PE equipment 22, 32. The CE equipment 24, 34 represents communication equipment, illustratively routers or other network elements like bridges, switches, etc., associated with an owner or operator of the end user equipment 26, 28 and 36, 38 such as a corporate owner of employee work stations. Communication equipment associated with a provider of communication services, an Internet Service Provider (ISP), for example, is similarly represented by the PE equipment 22, 32, which may also be routers or other types of communication network elements.

Ingress communication traffic which is received from CE equipment 24, 34 is routed on connections within the communication network 12 by PE equipment 22, 32. PE equipment 22, 32 also routes egress communication traffic which is destined for CE equipment 24, 34 or end user equipment 26, 28 or 36, 38 connected thereto. These PE equipment routing functions may be performed using VRF tables, which might map private Internet Protocol (IP) addresses to CE equipment interfaces, where one or more VPN services are provided in the communication network 12. In one embodiment, PE equipment 22, 32 stores a respective per-CE VRF table for each of its CE connections through which it communicates VPN traffic. However, it should be appreciated that PE equipment does not necessarily store per-CE VRF tables. The VRF tables are typically, though not necessarily, stored on a per customer site basis.

Routing within the communication network 12 may use similar or different routing and addressing schemes. The PE equipment 22, 32 and core network equipment may both route IP traffic, for example, but using different address spaces. Whereas a VPN may use private IP addresses that are unique within a VPN service, the communication network 12 may use public IP addresses.

As those skilled in the art will appreciate, VPN services in a communication system such as the system 10 may be established in any of various ways. Traffic routes, VRF tables, or other types of routing information may be learned by and advertised between the PE equipment 22, 32 using BGP, for example, to control how service sites such as the CE equipment 24, 34 communicate. RTs may be used in BGP to determine whether advertised routes should be added to particular VRF tables. A VRF table has configurable import and export RTs. When the PE equipment 22 receives a route update message or analogous information from the PE 32 for instance, it checks export RTs in the received information and adds received routes or routing information to any VRF tables that have been configured with import RTs that match one or more of the received export RTs. The PE equipment 22 may also advertise or otherwise distribute routes from its VRF tables and include with those routes any RTs associated with the VRF table or the corresponding CE equipment connection from which those routes were learned.

In this example, BGP and RTs are used to control which service sites, specifically which CE equipment 24, 34 in the system 10, can participate in a VPN service. CE equipment 24, 34 can communicate through a VPN service if an RT is common to their corresponding import and export RTs and CE equipment routes have been distributed between the PE equipment 22, 32.

Embodiments of the present invention relate primarily to managing VPN services that have been configured in a communication system. The configuration of those services is thus described herein only briefly, to the extent necessary to demonstrate aspects of the invention. The use of BGP and RTs, for example, will be familiar to those skilled in the art to which the invention pertains. Further details on RTs and route distribution are included in the above-noted RFC document. Other possible configuration mechanisms in conjunction with which embodiments of the invention may be implemented will similarly be or may become apparent to those skilled in the art.

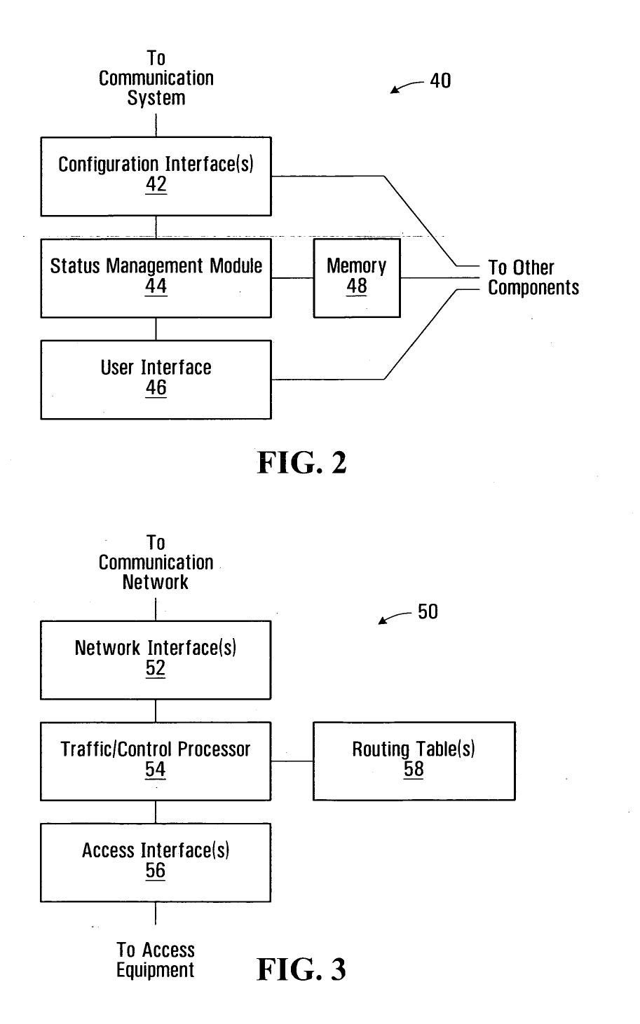

In the system 10, management and control functions such as configuration of VPN services and VPN service status management in accordance with aspects of the present invention may be enabled by the NMS 14. The NMS 14 is operatively coupled to, and exchanges at least control information such as VPN service configuration information with, the PE equipment 22, 32. Control paths between the NMS 14 and the PE equipment 22, 32 may share the same network connections as data paths through the communication network 12, although separate, dedicated control connections may be provided in some embodiments. An illustrative example of an NMS 14 is shown in FIG. 2 and described below.

The nature and extent of interactions between the NMS 14 and the PE equipment 22, 32 may vary for different types of communication networks and components. For example, in some types of communication networks, the NMS 14 may be involved in setting up communication paths between the PE equipment 22, 32. VPN service configuration may also involve the NMS 14. In the context of the present invention, however, the NMS 14 represents one example of a component at which VPN service management may be supported. Some embodiments may provide VPN service status management functions at the PE equipment 22, 32, or at another component of a communication system.

As discussed above, there may be a need to selectively manage the status of VPN services to one or more service sites or to all of the service sites in a VPN service. Where a service site is a participant in more than one VPN service, any such managed status change should be limited to a single VPN only.

In the present application, the term “service site” is used to generally refer to communication equipment or components, illustratively the CE equipment 24, 34, that participate in a VPN service. Such equipment or components may be deployed at particular physical locations to which VPN service is provided. A service site that participates in a VPN service and has an active or analogous status with respect to that VPN service can exchange communication traffic with other service sites that are also participants in the VPN service and have active statuses with respect to the VPN service. References made herein to service sites should be interpreted accordingly.

Selective status management might appear to be relatively simple in the system 10 of FIG. 1, which includes only two installations of PE equipment 22, 32, and two installations of CE equipment 24, 34. In modern communication systems, however, there can be thousands or more service sites participating in thousands or more VPN services. The extent of the selective management problem becomes apparent when considering a system of this scale. Suppose a service site that participates in two VPN services, which each include 10 service sites, is to be removed from only one of those VPN services, for example. It would be necessary to identify the RT(s) associated with the VPN service from which the service site is to be removed, and to remove the identified RT(s) from the configuration of the service site's VRF table. Since RTs are simply numbers, it tends to be very time intensive to locate and manually remove RTs from VRF tables. This process is also prone to error. For these reasons, the service site would normally be removed from both VPN services by disabling a connection or other physical interface through which the service site communicates with the VPN services. The difficulties associated with manually identifying and modifying RTs also complicate the process of disabling an entire VPN.

In accordance with aspects of the present invention, a service-specific status of a service site with respect to each VPN service in which the service site participates is independently manageable.

FIG. 2 is a block diagram of a VPN service status management apparatus. The apparatus 40 includes one or more configuration interfaces 42, a status management module 44 operatively coupled to the configuration interface(s) 42, a User Interface (UI) 46 operatively coupled to the status management module 44, and a memory 48 operatively coupled to the status management module 44.

A component or equipment in which the apparatus 40 is implemented may include other components that have not been explicitly shown in FIG. 2. A network management system, for instance, may include other physical components and/or functional modules for performing various control and management tasks in addition to VPN service status management.

The types of connections through which the components of FIG. 2 are operatively coupled may, to at least some extent, be implementation-dependent. Communication equipment components often use various types of physical connectors and wired connections such as midplane and backplane conductors, although the present invention is in no way limited to wired connections. In the case of cooperating software functions, for example, an operative coupling may be through variables or registers, and thus moreso a logical coupling than a direct physical coupling. Interconnections might also include other than local connections, as in the case of a remote operator terminal that connects to an NMS through a communication network connection, for example.

The configuration interface(s) 42 may include one or more interfaces through which the apparatus 40 exchanges configuration information with a communication system. With reference to FIG. 1, the NMS 14 may transmit and/or receive RTs and other configuration information with all PE equipment 22, 32 through the same type of interface or even through the same interface. Different types of interfaces may be provided when the apparatus 40 is implemented in a communication system component other than an NMS.

The particular structure of the interface(s) 42 may be dependent upon the information transfer mechanisms to be supported and the type of communication medium over which information is to be transferred. A single interface may support all configuration functions, or multiple interfaces may be provided for exchanging configuration information with different types of components or equipment. Those skilled in the art will be familiar with many different types of interfaces, and other types of interfaces that are subsequently developed may also be suitable for implementation as an interface 42 in the apparatus 40.

Hardware, software, firmware, or combinations thereof may be used to implement the configuration interface(s) 42. Components that may be suitable for implementing the interface(s) 42 include, among others, microprocessors, microcontrollers, programmable logic devices (PLDs), Field Programmable Gate Arrays (FPGAs), Application Specific Integrated Circuits (ASICs), and other types of “intelligent” integrated circuits.

The status management module 44 may also be implemented using hardware, software, and/or firmware. This module is therefore described herein primarily in terms of its function. Based on the functional description, a person skilled in the art will be enabled to implemented the status management module in any of various ways.

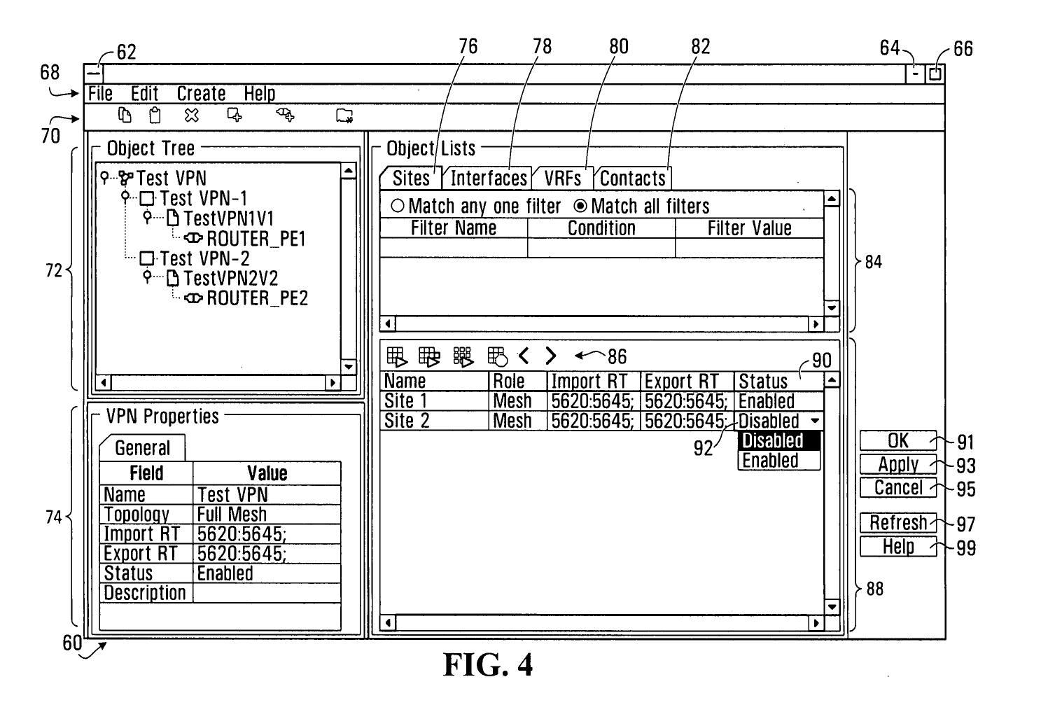

The user interface 46 includes one or more devices for receiving inputs from a user, providing outputs to a user, or both. A keyboard, mouse, and display are examples of such devices. In one embodiment, an operator terminal through which a user interacts with an NMS includes a display on which a GUI is presented. FIG. 4, described in detail below, illustrates an example of such a GUI.

Other types of interface, such as a system to system communication interface may also or instead be provided in the apparatus 40. The user interface 46 allows a user to control the status management module 44, as described above. A system to system interface enables control of the status management module 44 by an Operational Support System (OSS) or other system. In some embodiments, user and system control are supported.

Information relating to current configurations of equipment and services in a communication system, in the form of object models for instance, may be stored in a system database in the memory 48. Solid state memory devices are often used for this purpose, although embodiments in which other types of storage media, including movable and possibly removable storage media, are used to implement the memory 48 are also contemplated. Data structures that may be used in the memory 48 according to some embodiments are shown in FIGS. 6 to 10 and described below.

In operation, the configuration interface(s) 42 enables the exchange of at least VPN service configuration information with a communication system. As noted above, the configuration of VPN services may be supported by a service status management apparatus such as 40 or by a different apparatus or system.

Once VPN services have been configured in a communication system, the status management module 44 manages service-specific statuses of service sites in the communication system. The status of a service site with respect to one VPN service is managed by the status management module 44 independently of a service-specific status of the same service site with respect to any other VPN services in which the service site participates. The service site may be disabled in one VPN service but remain enabled in another, different VPN service.

A service site may be considered to have an “enabled”, “active”, or analogous service-specific status with respect to a VPN service if it can exchange communication traffic with other participants of that VPN service. A VPN service itself may also have a status. When enabled/active service sites of a VPN service are connected and capable of exchanging data, the VPN service may be considered to have an “enabled”, “active”, or analogous overall state. Current states and other VPN service and service site information may be maintained by the status management module 44 in the memory 48.

According to one embodiment of the invention, the status management module 44 manages the service-specific status of a service site with respect to a particular VPN service by managing communication traffic routing tables associated with the VPN service. These routing tables may be VRF tables, for example. In this case, service-specific status management is accomplished by ensuring appropriate RT configurations in the VRF table(s) corresponding to one or more service sites. Where a single service site is to be removed from a VPN, this may involve removing one or more RTs associated with that VPN from the import and export RTs of a VRF table that is associated with the service site. A VRF table is considered to be associated with a service site in a PE/CE-based VPN service, for example, if the VRF table is associated with any PE interface for that service site.

In the case of disabling a VPN service entirely, the RT(s) associated with that VPN service would be removed from all VRF tables of all service sites of the VPN service. Disabling a VPN service need not necessarily delete the VPN service from a database in the memory 48, but instead reconfigures RTs at service sites such that the capability to exchange data as members of that VPN no longer exists.

Changes in RTs or other configuration information may be effected by the status management module 44 in a substantially similar manner as that configuration information is established when a VPN service is initially configured. Thus, at least some embodiments of the invention may be implemented without requiring changes to configuration protocols or mechanisms.

A change in status of one service site with respect to a VPN service may affect other service sites of that VPN service to the extent that they interact with the status affected service site. Communication traffic should not be routed to a service site that has been removed from a VPN service, for example. Routes that are associated with a disabled service site should therefore be removed from the routing information such as VRF tables for other service sites.

In some embodiments, the status management module 44 relies on a normal route distribution mechanism, whereby an affected service site or another component such as PE equipment connected to a service site communicates a change in the service-specific status of the service site to one or more other service sites in normal update messages or in custom route update/removal commands. PE equipment may communicate route tables using BGP, for example. The configuration of RTs on the appropriate VRF tables within PE equipment, as performed by the status management module 44, then ultimately results in the PE equipment only importing the appropriate routes and rejecting others which do not conform to correct, updated RTs.

The route update process may, in other embodiments, be handled by the status management module 44 directly, such as by transmitting control commands, update messages, or other information to each service site of a VPN service.

Configuration changes for status management at the VPN service level may be handled in a substantially similar manner. If an entire VPN service is to be disabled, for example, then the service-specific status of each service site in a communication system may be changed by the status management module 44 to a “disabled” or analogous status, illustratively by removing RTs from VRF tables and updating routes. For this purpose, the status management module 44 may access information in the memory 48 to determine which service sites are participants in a VPN service and which RT(s) are associated with a VPN service.

As noted above, disabling a VPN service need not necessarily delete that service. Information associated with a disabled service may be maintained in the memory 48. For example, it may be useful to have a record of which service sites were enabled for a VPN service when that service was disabled. This would allow the VPN service to be subsequently re-started with the service sites which were disabled when the VPN service was previously running remaining disabled, and the enabled service sites getting enabled.

The UI 46 allows a user to select a VPN service, a service site, and a status management function to be performed for the VPN service and the service site. Any of various mechanisms may be supported for this purpose. In one embodiment, the UI 46 supports a network management GUI in which a visual representation of a VPN service, its service sites, and the service-specific status of each service site are presented. Selection of a service site and a status management function in this representation causes the status management module 44 to perform the status management function. An example of such a representation and one possible mechanism for invoking a status management function is described in further detail below with reference to FIG. 4.

Status management according to the techniques disclosed herein may involve existing VPN configuration and management protocols such as BGP, or possibly custom protocols and transfer mechanisms. Whether existing or new configuration and management schemes are used, status management may entail processing of some sort of control information at a service site or a component such as PE equipment through which VPN service is provided to a service site. FIG. 3 is a block diagram of communication equipment, which may be a service site or other equipment such as PE equipment that is associated with a service site.

The equipment 50 includes one or more network interfaces 52, a traffic/control processor 54 operatively coupled to the network interface(s) 52, one or more access interface(s) 56 operatively coupled to the traffic/control processor 54, and one or more routing tables 58, stored in a memory such as a solid state memory that is operatively coupled to the traffic/control processor 54. Communication equipment may include other components that have not been explicitly shown in FIG. 3 so as to avoid overly complicating the drawing.

As in the apparatus 40 of FIG. 2, the components of the equipment 50 of FIG. 3 may be operatively coupled through any of various types of connections, including logical and/or physical connections.

The network interface(s) 42 and the access interface(s) 56 may each include one or more interfaces through which the equipment 50 exchanges communication traffic and control information with either communication network elements such as other communication equipment and an NMS or access communication equipment such as CE equipment. The structure and function of these interface(s) 52, 56 may be dependent upon the transfer mechanisms to be supported and the types of communication media over which traffic and/or control information is to be transferred. Those skilled in the art will be familiar with many different types of interfaces, and other types of interfaces that are subsequently developed may also be suitable for implementation as an interface 52, 56 in the equipment 50. It should be appreciated that both network and access interfaces 52, 56 might not be provided in all embodiments. A status management apparatus may interact with a service site directly instead of through an intermediate component such as PE equipment, for instance.

Any or all of the interface(s) 52, 56, and also the traffic/control processor 54, may be implemented in hardware, software, firmware, or combinations thereof.

Received communication traffic and control information is processed by the traffic/control processor 54. Communication traffic is processed to determine a destination and is routed toward that destination, through a network interface 52 or an access interface 56, based on information in the routing table(s) 58. For VPN service communication traffic, the traffic/control processor 54 may refer to VRF tables, although other types of routing tables or routing information may also or instead be used.

As noted above, status management in accordance with embodiments of the invention may involve modifying RTs, which in turn affect the routes that are added to VRF tables. Thus, although embodiments of the invention may affect communication traffic routing, the actual routing of traffic may be separately implemented and otherwise substantially independent of VPN service-specific status management.

In the context of VPN services and traffic routing, the traffic/control processor 54 may support a protocol such as BGP. The traffic/control processor 54 may thus transmit, receive, or both transmit and receive routing advertisements and/or other types of configuration information, and perform such operations as populating and updating VRF tables. The traffic/control processor 54 may also be involved in controlling the status of a service site, or possibly multiple service sites where PE equipment is connected to multiple installations of CE equipment for instance, by configuring VRF table RTs responsive to control or configuration information or commands received from a status management module. In another embodiment, RTs are more directly configurable by a status management apparatus through a network interface, such that PE equipment and other components that provide VPN service to a service site need not be involved in status management. A status management apparatus, at an NMS for example, can thereby manage the service-specific status of a service site that is operatively coupled to the equipment 50 by managing an RT configuration of the equipment in any of various ways.

The traffic/control processor 54 may also be involved in updating other equipment or service sites when the status of a service site to which it is operatively coupled changes. A routing update message, a special command, or other information may be transmitted by the traffic/control processor 54 to other service sites when a set of RTs associated with a VRF table is revised. Such a transmission may be part of a normal update process in a protocol such as BGP. As noted above, this update process may instead be handled by a status management apparatus. Another embodiment might involve an update process that is handled by a service site or an associated component but invoked by a status management apparatus.

If routing updates are part of normal communication equipment operations, as in the case of PE equipment routing updates for instance, operation of the equipment 50 is not substantially altered by implementing service site status management. Once RTs in VRFs at PE equipment are modified by a status management apparatus, for example, the PE equipment operates in a normal fashion to distribute routes, process communication traffic, etc.

With reference now to FIG. 4, UI aspects of the present invention will be considered. FIG. 4 is a block diagram of a GUI, and specifically a VPN service form or screen 60 that may be displayed to a user at an operator terminal on which a network management software application is running. A complete network management GUI may include the screen 60, as well as other screens that are provided for VPN service management or additional management tasks.

The screen 60 includes relatively common functional graphical elements 62, 64, 66 to close, minimize, or maximize the screen, respectively, on a display device. File, edit, create, and help menus in a toolbar at 68 may allow a user to perform various tasks such as saving VPN service information to a file, printing the screen 60, copying information from and/or pasting information to the screen 60, creating a new VPN service, and accessing help information. Functions are also accessible through the icons at 70. The icons 70 invoke a copy function, a paste function, an unassign function to delete an assignment of an interface to a service site, an add site function to add a new service site to the VPN service, an add interface function to add to the VPN service an interface through which a service site communicates, and a new contact function to add a new contact for the VPN service.

The screen 60 also includes a graphical element 72 that provides a tree view of the VPN service, which in this example includes two PE routers. The graphical element 74 identifies the VPN service by name, “Test VPN”, and also provides other information relating to the service, including topology, import RTs, export RTs, status, and a description, which is blank for the “Test VPN” service.

The graphical element 88 provides site information in the example shown in FIG. 4. Interface, VRF, and contacts information may also be displayed by selecting a different one of the tabs 76, 78, 80, 82. The information presented at 88 may be limited according to filter parameters entered or selected at 84. The icons at 86 allow the user to create filtered lists of objects associated with the VPN service, according to parameters at 84. A VPN service can have any or all of customer service sites, PE equipment interfaces, VRFs, and contacts associated with it. The different icons at 86 allow a user to make a list, make a list and save it to a file, count items, stop the making of a list, and to step through pages of resultant object lists.

Service site information shown at 88 includes a service site name, a role, import RTs, export RTs, and a service-specific status 90 for each service site of the VPN service. Service site import and export RTs may include only those RTs that relate to the “Test VPN” service, or all RTs that a service site is configured to import and export. The service-specific status 90 is a status of the service site with respect to the VPN service. A service site may have a different status with respect to a different VPN service.

As shown at 92, a graphical element that indicates the service-specific status of a service site may be a functional graphical element, which provides access to a status management function for managing the service-specific status of the service site with respect to the VPN service. In the example shown, the status management function is a function to change a service site's service-specific status between disabled and enabled, and is accessible in a pulldown menu. The status pulldown menu might be displayed when a mouse button is clicked while a mouse pointer is positioned over a service site's status indication, for example. Other function access mechanisms are also contemplated, and may be or become apparent to those skilled in the art. It should be noted that, according to an aspect of the invention, changing the service-specific status of a service site in the screen 60 affects the service site's status with respect only to the VPN service “Test VPN”. If the service site also participates in any other VPN services, its status with respect to those VPN services is not affected by changing the service-specific status of the service site for the VPN service “Test VPN”.

Status of the entire VPN service may be managed in a substantially similar manner, by providing a pulldown menu or other access mechanism for the VPN service status graphical element at 74. Responsive to a change in VPN service status, the status of each service site that is part of the VPN service may be changed accordingly. As noted above, a record of current service-specific site statuses at the time a VPN service is disabled may be maintained in memory and accessed if the VPN service is subsequently restored.

Changes made in the screen 60 are saved by selecting the button 91, or possibly by selecting a save option in a File pulldown menu at 68. Selecting the button 93 causes service or service site status changes to be updated in a communication system. Illustrative examples of the operations that may be involved in this process have been described above. The button 95 allows a user to exit the screen 60 without saving or applying changes. Information in the screen 60 may be refreshed from a network or system database by selecting the button 97. Help information is accessible by selecting the button 99. The button 99 need not necessarily provide access to the same help information as the Help item in the toolbar at 68. The toolbar Help option might provide general network management software application help information, whereas context-sensitive help information is displayed when the button 99 is selected, for example.

The screen 60 is one example of a screen in which VPN service information may be presented. The particular layout, form, functions, and/or information presented in a GUI or other user interface may be different than explicitly shown. The invention is in no way limited to the screen 60, or to any other specific manner of presenting VPN service information.

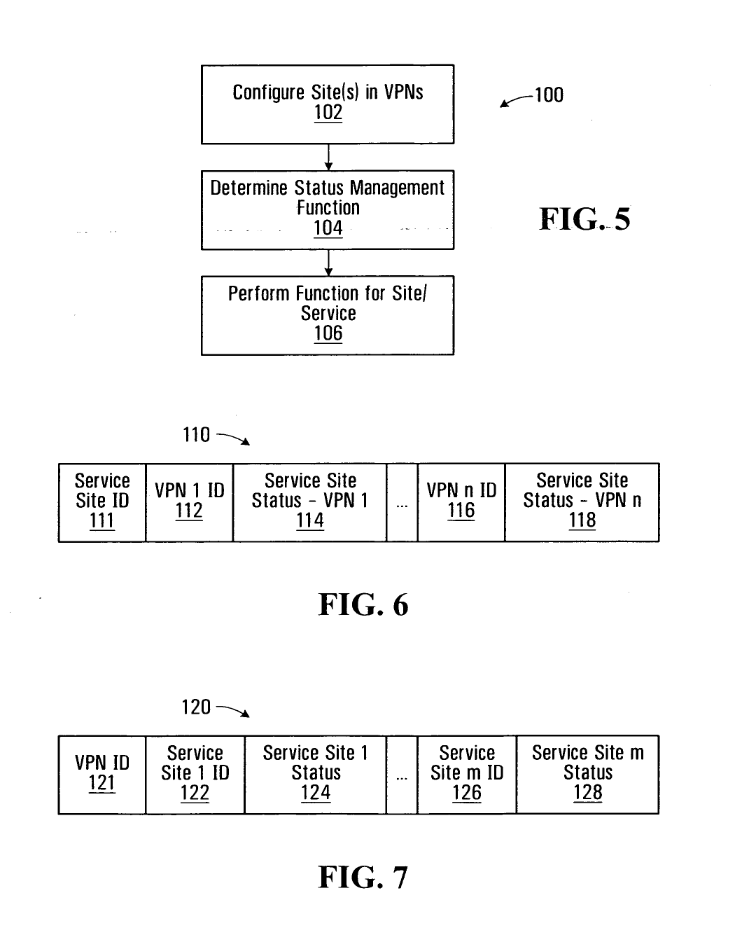

FIG. 5 is a block diagram of a VPN service status management method. The method 100 involves an operation 102 of configuring one or more service sites in a communication system for participation in multiple different VPN services. Actual configuration of VPN services at 102 need not necessarily be performed by a status management system. A status management system may thus manage VPN services that have been configured by other components of a communication system.

At 104, a determination is made as to whether a service-specific status management function is to be performed for a service site with respect to a VPN service. This determination may involve detecting a user selection of a status management function, illustratively a function to change the status of a service site or to change the status of an entire VPN service. The determined status management function is then automatically performed at 106. As described in detail herein, a status management module automatically determines the actions that are to be taken to perform a status management function, such as by identifying RTs and also identifying service sites in the case of a change in status for an entire VPN service. The status management function performed at 106 affects the status of one or more service sites with respect to one VPN service. A service-specific status for the service site(s) with respect to a different VPN service is maintained.

The method 100 is illustrative of one embodiment of the invention. Various ways of performing the operations at 102, 104, 106 will be apparent to those skilled in the art. The determining operation at 104, for example, might involve determining a status management function to be performed for a VPN service, and determining a service-specific status management function to be performed for one or more service sites based on the service status management function.

More generally, embodiments of the invention may involve fewer, further, or different operations, performed in a similar or different order than explicitly shown. At least some variations of the method 100 will be apparent from the foregoing apparatus and equipment descriptions, and others may be or become apparent to those skilled in the art.

FIG. 6 is a block diagram of a VPN service site data structure 110, which may be stored in the memory 48 (FIG. 2) for use by the status management module 44. A service site identified by a number, name, or other identifier 111 may participate in a number “n” of VPN services. An identifier of each VPN service and a service-specific status of the service site with respect to each of those VPN services are included in the data structure 110 at 112/114, 116/118. By accessing the data structure 110 for a service site, a status management module is able to determine and maintain a current record of the participation and status of the service site in VPN services. Other information such as import and export RTs may also be stored in a service site data structure.

FIG. 7 is a block diagram of a VPN service data structure 120, which may also or instead be stored in the memory 48 (FIG. 2) for use by the status management module 44. A VPN service identified by a number, name, or other identifier 121 may have a number “m” of participating service sites. An identifier of each service site and a service-specific status of the service site with respect to the VPN service are included in the data structure 120 at 122/124, 126/128. A status management module can thereby access the data structure 120 to determine and update a list of service sites participating in the VPN service and the status of the service sites with respect to the VPN service. Other information such as a status of the VPN service, and the RT(s) associated with the VPN service may also be stored in a VPN service data structure.

Embodiments of the invention may use either or both of service site and VPN service data structures such as 110, 120. Both types of data structure include an identifier of one or more VPN services and an indication of a service-specific status of one or more service sites with respect to the VPN service(s).

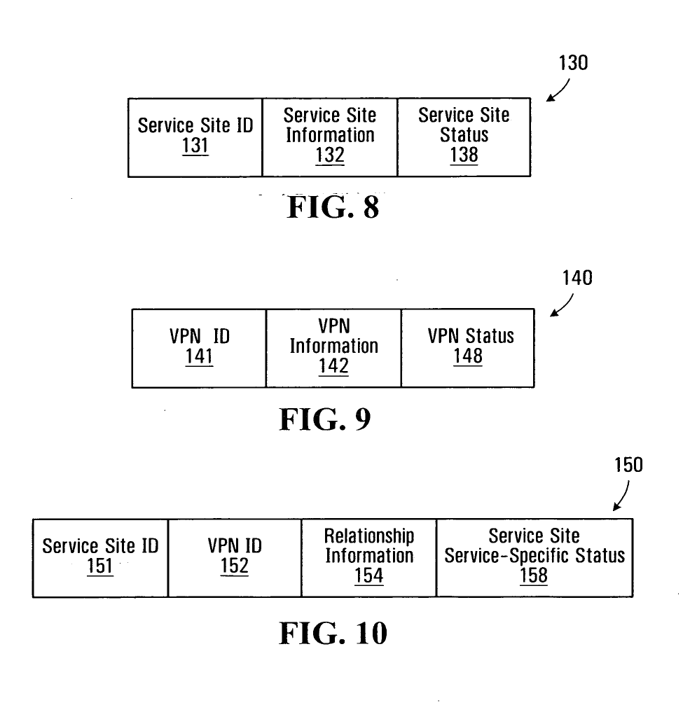

The present invention is in no way limited the data structures 110, 120 or to any other specific data structures. Another example of a set of data structures that may be used VPN service management is shown in FIGS. 8 to 10.

FIG. 8 is a block diagram of a VPN service site data structure 130, which includes a service site ID 131, service site information 132, and an indication 138 of the overall status of a service site. A service site may be identified at 131 by a number, name, or other identifier. Service site information such as a description may be included in the data structure 130 at 132. Like a VPN service, a service site may have an overall status, which is included in the data structure 130 at 138. The service-specific status of a service site in all VPN services can be managed using the site status 138. This may be useful, for example, where a service site is serviced by multiple PE equipment interfaces. In this case, the overall site status may be changed in a status management GUI to cause a status management module to automatically modify VRF table RTs or otherwise bring down all of the associated interfaces.

A VPN service data structure 140 is shown in FIG. 9. The data structure 140 includes a VPN service number, name, or other identifier at 141. Other information for the VPN service, such as a description, RTs, etc., is included at 142. The data structure 140 also includes at 148 an indication of overall status of the VPN, which may be managed in some embodiments.

As will be apparent from FIGS. 6 and 7 and the foregoing description, relationships between service sites and VPN services are inherent in the data structures 110, 120, but not in the data structures 130, 140. FIG. 10 is a block diagram of a relationship data structure that may be used to specify relationships between service sites and VPN services, where service sites and VPN services are modelled in data structures such as 130, 140.

A set of relationships between service sites and VPN services may be many-to-many. A service site may be related with 0 or more VPN services. A VPN service may be associated with 0 or more service sites. The data structure 150 is an example of a data structure that allows these types of relationships to be managed separately. This data structure 150 includes identifiers 151, 152 of a service site and a VPN service, relationship information 154 as it pertains to the service site and the VPN service, and an indication 158 of a service-specific status of the service site with respect to the VPN service. The relationship information 154 may include, for example, a role of the service site in the VPN service, illustratively “Mesh”, “Hub”, “Spoke”, etc., RTs that are associated with the service site and the VPN service, and/or other information pertaining to a VPN service and a service site.

A status management module may automatically determine any information that should be manipulated to perform a particular status management function by accessing the data structures shown in FIGS. 6 to 10. Based on a selected service site and VPN service, for example, a status management module can locate the correct relationship data structure 150 for that service site and VPN service and determine from the relationship information 154 the RT(s) that are to be changed in order to disable the service site in the VPN service. Other status management functions may be performed in a substantially similar manner, by creating, deleting, and/or accessing various data structures.

In accordance with an aspect of the invention as described above, VRF tables may be configured with appropriate RT values to control the participation of one or more service sites in one or more VPN services. RT configuration is performed automatically, ensuring that VPN service communication traffic is only exchanged with service sites of the VPN service, and does not leak to unintended service sites such as disabled service sites. Manual manipulation of RTs, which is both tedious and error prone, is avoided.

As the deployment of VPN services such as L3 VPN services grows, with service sites subscribing to more than one VPN service, there may be a need to manage the status of VPN services on a per-VPN service basis, not on a per-service site basis. Embodiments of the present invention may be used to provide this capability. The operational status of a VPN service in a communication system is manageable by automatically disabling or enabling the operational state of a service sites or all service sites of the VPN service. In one embodiment, an NMS automatically modifies RT configurations in VRF tables of systems that are connected to a communication network and that subscribe to a VPN service, such that the ability of any of the systems to interchange communication traffic with any others of those systems via the VPN service is disabled or enabled.

What has been described is merely illustrative of the application of principles of embodiments of the invention. Other arrangements and methods can be implemented by those skilled in the art without departing from the scope of the present invention.

For example, the invention is not limited to any particular configuration or management protocols or techniques. BGP represents one, but not the only, protocol that may be used in embodiments of the invention.

The division of functions shown in FIGS. 2 and 3 and described above are also intended solely for illustrative purposes. The functions disclosed herein may be provided by fewer or more components than explicitly shown.

Disabling a VPN service or a service site provides a useful example of a status management operation that could be performed according to embodiments of the invention. Other status management functions, such as enabling a previously disabled VPN service or service site, for example, could be accomplished using substantially similar techniques.

In addition, although described primarily in the context of methods and systems, other implementations of the invention are contemplated, as instructions stored on a machine-readable medium, for example.

We claim:

1. An apparatus comprising:
a configuration interface for exchanging Virtual Private Network (VPN) service configuration information with a communication system; and
a status management module, operatively coupled to the configuration interface, for managing a service-specific status of a service site in the communication system with respect to a VPN service independently of a service-specific status of the service site with respect to a different VPN service with which the service site is associated.

2. The apparatus of claim 1, wherein the status management module is configured to manage the service-specific status of the service site with respect to the VPN service by managing a communication traffic routing table associated with the VPN service.

3. The apparatus of claim 1, wherein the service site comprises Customer Edge (CE) communication equipment operatively coupled to Provide Edge (PE) communication equipment, and wherein the status management module is configured to manage the service-specific status of the service site with respect to the VPN service by managing a Route Target (RT) configuration of the PE communication equipment.

4. The apparatus of claim 1, wherein the VPN service comprises the service site and a further service site, and wherein the status management module or the service site communicates a change in the service-specific status of the service site to the further service site.

5. The apparatus of claim 3, wherein the VPN service comprises the service site and a further service site, the further service site comprising CE communication equipment operatively coupled to PE communication equipment, and wherein the status management module or the PE communication equipment at the service site communicates a change in the service-specific status of the service site to the PE communication equipment at the further service site.

6. The apparatus of claim 1, further comprising:
a user interface (UI), operatively coupled to the status management module, for allowing a user to select the VPN service, the service site, and a status management function,
wherein the status management module performs the selected status management function for the service-specific status of the service site with respect to the VPN service responsive to a user selection of the VPN service, the service site, and the status management function.

7. The apparatus of claim 6, wherein the UI provides a visual representation of the service site and the service-specific status of the service site with respect to the VPN service responsive to a user selection of the VPN service, and wherein the status management module performs the selected status management function for the service-specific status of the service site with respect to the VPN service responsive to a user selection of the status management function.

8. The apparatus of claim 1, wherein the status management module is further operable for managing a status of the VPN service, the status management module managing the service-specific status of the service site with respect to the VPN service in accordance with a status of the VPN service.

9. A network management system comprising the apparatus of claim 1.

10. A machine-implemented method of managing a status of a service site in a communication system, the service site having been configured for participation in a plurality of different Virtual Private Network (VPN) services, the method comprising:
determining a service-specific status management function to be performed for the service site with respect to a VPN service of the plurality of VPN services; and
automatically performing the determined status management function for the service site with respect to the VPN service while maintaining a service-specific status for the service site with respect to a different VPN service of the plurality of VPN services.

11. The method of claim 10, wherein performing comprises identifying a Route Target (RT) associated with the VPN service, and removing the identified RT from a VPN Routing and Forwarding (VRF) table of the service site in the communication system.

12. The method of claim 10, wherein determining comprises determining a status management function to be performed for the VPN service, and determining the service-specific status management function to be performed for the service site based on the determined status management function to be performed for the VPN service.

13. A computer-readable medium storing instructions which when executed perform the method of claim 10.

14. A Graphical User Interface (GUI) comprising:
a graphical element identifying a Virtual Private Network (VPN) service, the VPN service comprising a service site; and
a graphical element indicating a service-specific status of the service site with respect to the VPN service.

15. The GUI of claim 14, wherein the VPN service comprises a plurality of service sites including the service site, and wherein the graphical element indicating a service-specific status comprises a respective graphical element indicating a service-specific status of each service site of the plurality of service sites.

16. The GUI of claim 14, further comprising:
a graphical element indicating a status of the VPN service.

17. The GUI of claim 14, wherein the graphical element indicating the service-specific status comprises a functional graphical element, the functional graphical element providing access to a status management function for managing the service-specific status of the service site with respect to the VPN service.

18. The GUI of claim 17, wherein the service site is associated with a plurality of different VPN services including the VPN service, and wherein the status management function manages the service-specific status of the service site with respect only to the VPN service.

19. A computer-readable medium storing a data structure, the data structure comprising:
an identifier of a Virtual Private Network (VPN) service, the VPN service comprising a service site; and
an indication of a service-specific status of the service site with respect to the VPN service.

20. The medium of claim 19, wherein the service site is associated with a plurality of different VPN services including the VPN service, wherein the data structure further includes an identifier of the service site, wherein the identifier of a VPN service comprises a respective identifier of each VPN service of the plurality of VPN services, and wherein the indication comprises a respective indication of a service-specific status of the service site with respect to each VPN service of the plurality of VPN services.

21. The medium of claim 19, wherein the VPN service comprises a plurality of service sites including the service site, and wherein the indication comprises a respective indication of a service-specific status of each service site of the plurality of service sites.

22. The medium of claim 19, wherein the service site is associated with a plurality of different VPN services including the VPN service, and wherein the data structure comprises a plurality of data structures, each data structure of the plurality of data structures comprising an identifier of the service site, an identifier of a respective one of the plurality of VPN services, relationship information associated with the service site and the one of the plurality of VPN services, and an indication of a service-specific status of the service site with respect to the one of the plurality of VPN services.

23. The medium of claim 19, wherein the VPN service comprises a plurality of service sites including the service site, and wherein the data structure comprises a plurality of data structures, each data structure of the plurality of data structures comprising an identifier of the VPN service, an identifier of a respective one of the plurality of service sites, relationship information associated with the VPN service and the one of the plurality of service sites, and an indication of a service-specific status of the one of the plurality of service sites with respect to the VPN service.
